(19) United States
(12) Patent Application Publication
(10) Pub. No.: US 2006/0290988 A1
(43) Pub. Date: Dec. 28, 2006

(54) Methods for setting frequency rate and angle difference between screens where moire pattern is not generated

(75) Inventors: Sang-ho Kim, Suwon-si (KR); Byong-min Kang, Incheon (KR); Choon-woo Kim, Seoul (KR); Seul-ki Jang, Incheon (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/433,669

(22) Filed: May 15, 2006

(30) Foreign Application Priority Data
Jun. 27, 2005 (KR) 2005-0055925

(51) Int. Cl. H04N 1/405

(52) U.S. Cl. 358/3.2; 358/3.26

(57) ABSTRACT

A method of setting frequency rate and angle differences between screens where moire patterns are not generated is provided. The method of setting the frequency rate and angle differences of the screens includes forming a binary image using at least two overlapped screens, and low-pass filtering the binary image to calculate an average reflectivity. A frequency component (cost) is calculated with respect to the binary image using the calculated average reflectivity. It is determined whether a moire pattern with respect to the binary image is generated based on the frequency component. Accordingly, the binary image where the moire pattern is not generated may be formed.

### CROSS-REFERENCE TO RELATED APPLICATIONS

This application claims the benefit under 35 U.S.C. § 119(a) of Korean Patent Application No. 2005-55925, filed on Jun. 27, 2005, the entire contents of which are hereby incorporated herein by reference.

### BACKGROUND OF THE INVENTION

1. Field of the Invention

The present invention relates to a method of setting a frequency and an angle of a screen where moire patterns are not generated. More particularly, the present invention relates to a method of setting a frequency and an angle of a screen by calculating frequency rates and angle differences between screens for substantially preventing the occurrence of moire patterns as poor patterns due to at least two overlapped screens.

2. Description of the Related Art

Generally, an image formation apparatus, such as a printer, uses binary data of one bit composed of “0”s and “1”s to make an image printed on a print sheet. That is, in a case of a “0”, one dot is not printed on the print sheet, and in a case of “1”, one dot is printed on the print sheet so that one image is resultantly formed on the print sheet. In this case, the image formation apparatus carries out halftoning, which converts general image data of 8 bits to binary data of 1 bit, and the image formation apparatus, such as a laser printer, uses a screening method for carrying out such halftoning.

The screening method is a halftoning technique for converting continuous gradation images to binary images, which converts incoming image data of 8 bits to binary data of 1 bit using a screen arranged in a plurality of matrices. Screens are classified into a clustered-dot type where dots corresponding to the binary data are arranged as closely to one another as possible, and a dispersed-dot type where dots corresponding to the binary data are spaced apart from one another as much as possible.

Screens are also classified into an ordered-dot type that has dots corresponding to binary data while having regularity in response to constant frequency and angle, and a stochastic-dot type where dots corresponding to binary data are irregularly formed. In this case, the above-described frequency means a basic frequency of a screen which indicates a number of dot patterns formed per unit length, and is also referred to LPI (lines per inch).

A sequentially ordered-dot type screen is used in the laser printer, and cyan (C), magenta (M), yellow (Y), and black (B) screens are used for representing the respective colors. Poor patterns, such as moire patterns, may occur in an image to be output to the print sheet in response to frequency rate and angle differences between the C, M, Y, and B screens. Among theses screens, the yellow screen insignificantly affects an occurrence of the moire pattern, so that a description thereof will be skipped.

Interferences between the C, M, and B screens cause the moire pattern to occur, which is referred to as an interscreen moire, and a method of setting the frequency and angle of the screen for minimizing the moire patterns of the related art will be described with reference to FIGS. 1 to 8.

FIG. 1 is a view illustrating a general moire pattern occurring when two screens overlap each other.

Referring to FIG. 1, a first screen having a frequency f1 and a second screen having a frequency f2 are arranged with given angles, respectively, and the two screens overlap each other to show the moire pattern.

FIG. 2 is a view illustrating the frequency and angle of the two screens shown in FIG. 1 as vector components.

Referring to FIG. 2, four frequency vectors are generated by the frequencies and angles of the first and second screens shown in FIG. 1. That is, ±(f₁+f₂) and ±(f₁−f₂) are generated, which are referred to as moire vectors. These moire vectors allows visibility circles to be divided where the moire patterns are generated, and a boundary of the visibility circles is given by a cut-off frequency. The cut-off frequency has a value of 0.5 cycle/degree, which is the maximum value in the Contrast Sensitivity Function (CSF). The value is 10.2556 cycle/inch at a distance of 20 inches.

A singular state corresponds to a case when a magnitude of the moire vector is 0, and in this case, the moire pattern is not generated. However, when a fine change of the frequency rate and the angle differences of the screen occurs, the moire pattern is generated. Additionally, a slightly-off state corresponds to a case when the magnitude of the moire vector is smaller than the cut-off frequency, and in this case, the moire pattern is generated. A stable state corresponds to a case when the magnitude of the moire vector is bigger than the cut-off frequency, and in this case, the moire pattern is not generated.

FIGS. 3A to 5B are views illustrating general patterns shown in response to frequency rate and angle differences between screens.

FIGS. 3A, 4A, and 5A illustrate patterns shown in response to the screen frequency rate and angle differences between screens in a case of the in-phase overlapping. The in-phase overlapping indicates that positions of start points (0, 0) of the respective screens are the same as one another. In contrast, FIGS. 3B, 4B, and 5B show patterns shown in response to the screen frequency rate and the angle differences in a case of the counter-phase overlapping. The counter-phase overlapping indicates that at least one position of start points (0, 0) of the screens is different from the rest of the start points.

FIGS. 3A and 3B correspond to the singular states. In this case, a rosette pattern is regularly shown, however, the moire pattern is not generated. The rosette pattern of FIG. 3A when in-phase is differently shown compared to when in counter-phase of FIG. 3B.

FIGS. 4A and 4B correspond to the slightly-off states. Representative patterns are alternately shown in cases of the in-phase of FIG. 4A and the counter-phase of FIG. 4B, so that the moire pattern is shown.

FIGS. 5A and 5B correspond to the stable states. Rosette patterns are shown in-phase in FIG. 5A and in counter-phase in FIG. 5B. However, the rosette patterns are different from each other and uniformly distributed, so that the moire pattern is not shown.

FIG. 6 is a view for explaining a method of discriminating a moire pattern of the related art.

Referring to FIG. 6, α (alpha) denotes an angle difference between the K and C screens, and β (beta) denotes an angle difference between the K and M screens. The frequency and the angle of the K screen are set to an initial frequency fₖ and 0°, respectively, and the presence or absence of the moire pattern is determined while the frequency and the angle of the C and M screens are changed.

That is, the moire vector (F_{k1, . . . , k6}) of each state is calculated by equation 1 below, which is then compared with the cut-off frequency, and it is determined that the moire pattern is shown when the moire vector (F_{k1, . . . , k6}) is bigger than the cut-off frequency, and that the moire pattern is not shown when the moire vector (F_{k1, . . . , k6}) is smaller than the cut-off frequency.
f_{k1 . . . k6}=\sqrt{u_{k1 . . . k6}²+v_{k1 . . . k6}²} equation 1

In this case, k₁ and k₂ denote indexes representing a harmonic frequency of the K screen, k₃ and k₄ denote indexes representing a harmonic frequency of the C screen, k₅ and k₆ denote indexes representing a harmonic frequency of the M screen, fₖ is an initial frequency of the K screen, u_{k1, . . . , k6} denote horizontal components of the moire vector in the frequency domain, which are calculated by the equation 2 below.
u_{k1, . . . , k6}=kₗfₖ+q_{MK}f_{K}[k₃ cos_{α}+k₄ cos(90°+α)]+q_{CK}f_{K}[k₅ cos(−β)+k₆ cos(90°−β)] equation 2

Additionally, v_{k1, . . . , k6} denote vertical components of the moire vector in the frequency domain, which are calculated by the equation 3 below.
v_{k1, . . . ,k6}kₗfₖq_{MK}f_{K}[k₃ sin_{α}+k₄ cos(90°+α)]+q_{CK}f_{K}[k₅ sin(−β)+k₆ sin(90°−β)] equation 3

In the equations 2 and 3, q_{CK} denotes a frequency rate (f_{C}/fₖ) between the K and C screens, and q_{CK} denotes a frequency rate (f_{M}/fₖ) between the K and M screens.

FIGS. 7A to 7C are views illustrating moire states in response to the frequency rate and angle differences between screens of the related art.

FIG. 7A shows the moire states in response to the angle difference α and β when the initial frequency of the K screen (fₖ) is 210 lpi and the frequency rate is q_{CK}=q_{MK}=1 (that is, frequencies of the C, M, and K are equal). In this case, the black area is an area where the moire pattern is generated, and the white area is an area where the moire pattern is not generated.

FIG. 7B shows the moire states in response to the angle difference α and β when the initial frequency of the K screen (fₖ) is 210 lpi and the frequency rate is q_{CK}=q_{MK}=0.5 to 1.5. In this case, the moire state is generated in all areas.

FIG. 7C shows the moire pattern in response to the angle difference α and β when the initial frequency of the K screen (fₖ) is 210 lpi and the frequency rate is q_{CK}=q_{MK}=0.82 to 0.84. In this case, the point ‘A’ indicates the frequency rate and angle difference between the C, M and K screens at the time of stable state. FIGS. 5A and 5B show images where screening has been carried out using the frequency rate and angle difference at the point ‘A’, so that the moire pattern is not shown even when a fine change in angle occurs.

FIG. 8 is a flow chart explaining a method of carrying out thresholding on the moire pattern in accordance with the related art.

Referring to FIG. 8, a user first sets frequency and angle of screens using a screen design device (not shown). That is, the frequency and the angle of the black screen K are set to an initial frequency (fₖ) and 0°, respectively, and the frequency and the angle of the C and M screens are set (S10).

In this case, the frequency and the angle of each screen are used to calculate the moire vector. That is, the frequency rate and angle differences between the C, M, and K screens are applied to the equation 1, so that a magnitude of the moire vector is calculated (S20).

In this case, the magnitude of the moire vector is compared with the cut-off frequency (S30). The moire vector is not generated when the magnitude of the moire vector is larger than the cut-off frequency. That is, when the magnitude of the moire vector is larger than the cut-off frequency, the stable state is determined where the moire vector is not generated as shown in FIGS. 5A and 5B (S40).

In contrast, when the magnitude of the moire vector is smaller than the cut-off frequency, the moire pattern is generated. That is, the slightly-off state is determined where the moire vector is generated as shown in FIGS. 4A and 4B, or the singular state is determined where the moire vector is not shown when the magnitude of the moire vector is 0 as shown in FIGS. 3A and 3B but has a high probability of generating the moire vector when the frequency and the angle are finely changed (S50).

Thresholding is carried out on the moire pattern in response to the screen frequency rate and angle differences set when the moire pattern is not shown in the step S40 as described above. Similarly, thresholding is carried out on the moire pattern in response to the screen frequency rate and angle differences set when the moire pattern is shown in step S50. The thresholding denoted herein means that white corresponds to a case when the moire pattern is not generated and black corresponds to a case when the moire pattern is generated as shown in FIG. 7 (S60).

The frequency and angle of the C and M screens are changed (S70). In this case, it is determined whether the change exceeds the frequency and the angle range of the screens, and the experiment is terminated when the change exceeds the frequency and the angle range. The steps S20 to S80 are repeatedly carried out when the change is within the range of the frequency and the angle of the screen. In this case, the ranges of the screen frequency rate and angle differences used herein are about 0.5 to 1.0, and 0° to 45°, respectively (S80).

In accordance with the method of the related art, the in-phase state and the counter-phase state are analyzed in the same states as each other although these states have different properties from each other. Additionally, the screen does not have the AM (Amplitude Modulation) ordered property, and cannot be analyzed when it has the AM stochastic property. The visual proper of human beings is different in response to frequency, so that the cut-off frequency may have a different weight value in response to the magnitude of the moire vector.

Accordingly, a need exists for a method of analyzing in-phase and counter-phase states while considering the different properties of each state in setting frequency and an angle of a screen such that moire patterns are not generated.

### SUMMARY OF THE INVENTION

An object of the present invention is to provide a method of setting frequency rate and angle differences between screens calculating an average reflectivity by means of overlapped binary images so that moire patterns are not generated.

Another object of the present invention is to provide a method of setting frequency rate and angle differences between screens taking into account differences between an in-phase state and a counter-phase state of the screen so that stable patterns are output and moire patterns are not generated.

Another object of the present invention is to provide a method of setting frequency rate and angle differences between screens where moire patterns are not generated in the screen having an Amplitude Modulation (AM) stochastic property.

According to one aspect of the present invention, a method of setting frequency rate and angle differences between screens includes forming a binary image using at least two overlapped screens, low-pass filtering the binary image to calculate an average reflectivity, calculating a frequency component (Cost) with respect to the binary image using the calculated average reflectivity, and determining whether a moire pattern with respect to the binary image is generated based on the frequency component.

Calculating the frequency component with respect to the binary image includes calculating the frequency component when the at least two screens are in an in-phase state where start points of the screens are the same as each other.

A slightly-off state in which the moire pattern is generated is, for example, determined using the calculated frequency component of the in-phase state.

The binary image is, for example, determined to be in the slightly-off state when the calculated frequency component of the in-phase state exceeds a first threshold value.

Additionally, in an exemplary embodiment, calculating the frequency component with respect to the binary image further includes calculating the frequency component when the at least two screens are in a counter-phase state where start points (0,0) of the screens are not the same as each other, and calculating a difference between the frequency component of the in-phase state and the frequency component of the counter-phase state.

The moire pattern is determined to be possibly in a singular state using the calculated difference between the frequency component of the in-phase state and the frequency component of the counter-phase state.

The binary image is determined to be in the singular state when the calculated difference between the frequency component of the in-phase state and the frequency component of the counter-phase state exceeds a second threshold value.

The binary image is determined to be in a stable state when the calculated frequency component of the in-phase does not exceed the first threshold value and the calculated difference between the frequency component of the in-phase state and the frequency component of the counter-phase state does not exceed the second threshold value.

In accordance with an exemplary method, an average reflectivity of a predetermined position ‘P’ of the binary image is calculated using the following equation: average reflectivity of ‘P’=a number of white pixels within unit area/unit area.

In the above-described equation, horizontal and vertical lengths of the unit area may, for example, be larger than a length of a dot pattern of the at least two screens.

In accordance with the method, calculating the frequency component (Cost) with respect to the binary image uses the following equation:

$$Cost = {\sum }_{α} {\sum }_{β} {MTF ( u , v )}^{2} ( X ( u , v ) \times X * ( u , v ) )$$

where the MTF (modulation transfer function) denotes a visual property of a human being, X(u,v)×X*(u,v) denotes a power spectrum of the binary image, and α and β denote angle differences between the at least two screens.

According to an exemplary implementation of the present invention, the method may further include carrying out thresholding depending on whether the moire pattern is generated, and setting frequency rate and angle differences between the at least two screens based on the thresholding value.

Other objects, advantages, and salient features of the invention will become apparent from the detailed description, which, taken in conjunction with the annexed drawings, discloses exemplary embodiments of the invention.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above aspects and features of the present invention will be more apparent by describing certain exemplary embodiments of the present invention with reference to the accompanying drawings, in which:

FIG. 1 is a view illustrating a general moire pattern when two screens overlap each other;

FIG. 2 is a view illustrating frequency and angle of two screens shown in FIG. 1 as vector components;

FIGS. 3A to 5B are views illustrating general patterns shown in response to frequency rate and angle differences between screens;

FIG. 6 is a view explaining a method of discriminating a moire pattern in accordance with the related art;

FIGS. 7A to 7C are views illustrating moire patterns in response to frequency rate and angle differences between screens;

FIG. 8 is a flow chart explaining a method of carrying out thresholding on the moire pattern in accordance with the related art;

FIGS. 9A to 11B are views explaining a method of obtaining an average reflectivity of a binary image in accordance with an exemplary embodiment of the present invention;

FIGS. 12A to 13D are views explaining a method of carrying out thresholding on the moire pattern in accordance with an exemplary embodiment of the present invention;

FIG. 14 is a view illustrating a pattern state in response to a frequency rate when calculated angles (α and β) are fixed in accordance with an exemplary embodiment of the present invention;

FIG. 15 is a flow chart explaining a method of carrying out thresholding on the moire pattern in accordance with an exemplary embodiment of the present invention;

FIGS. 16A and 16B are views illustrating screening results in response to frequency rate and angle differences in accordance with an exemplary embodiment of the present invention; and

FIGS. 17A to 17D are views illustrating evaluation results of screens having AM stochastic property in accordance with an exemplary embodiment of the present invention.

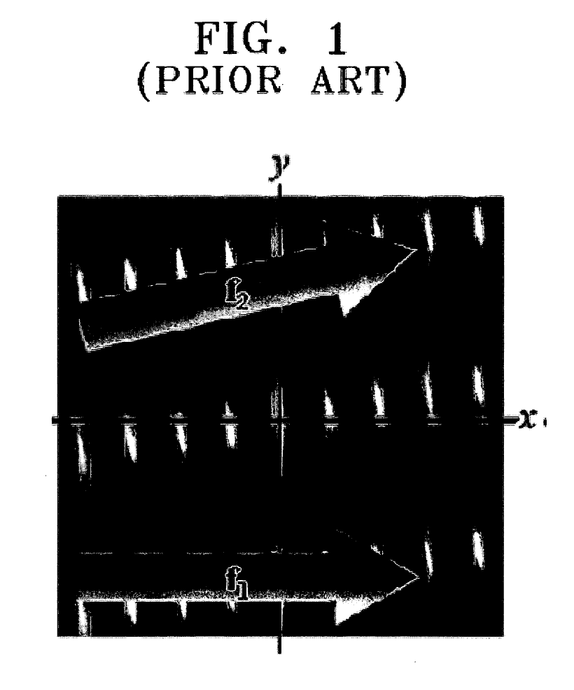

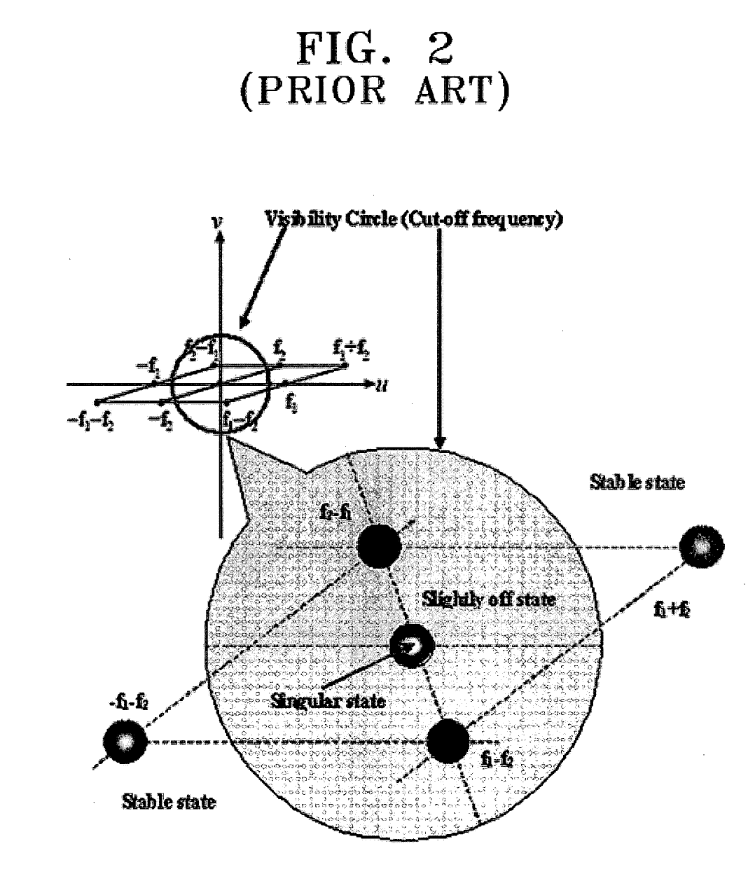

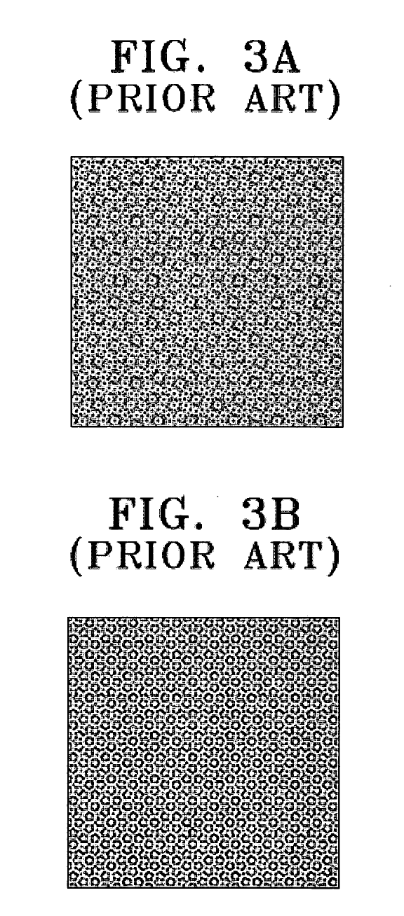

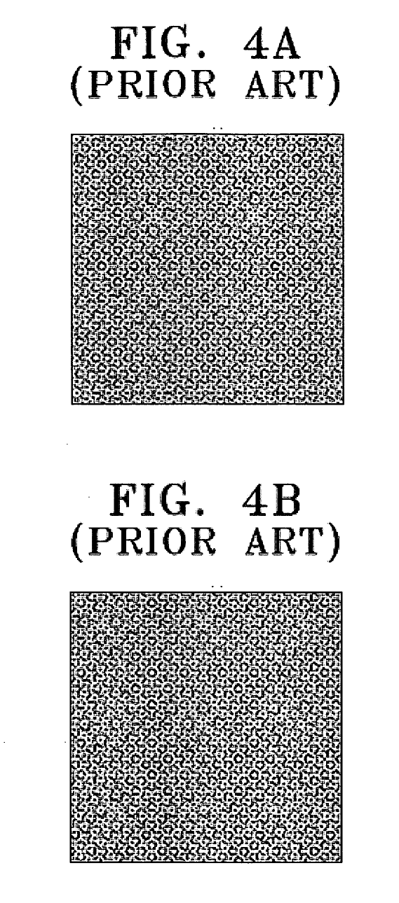

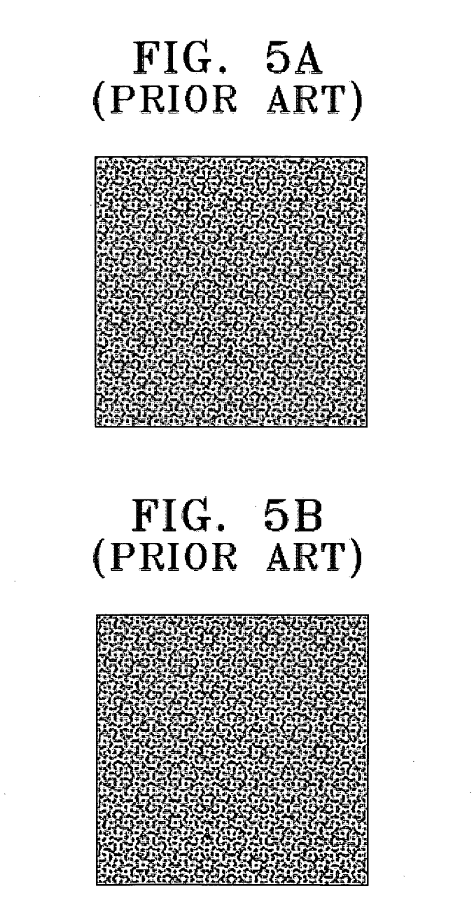

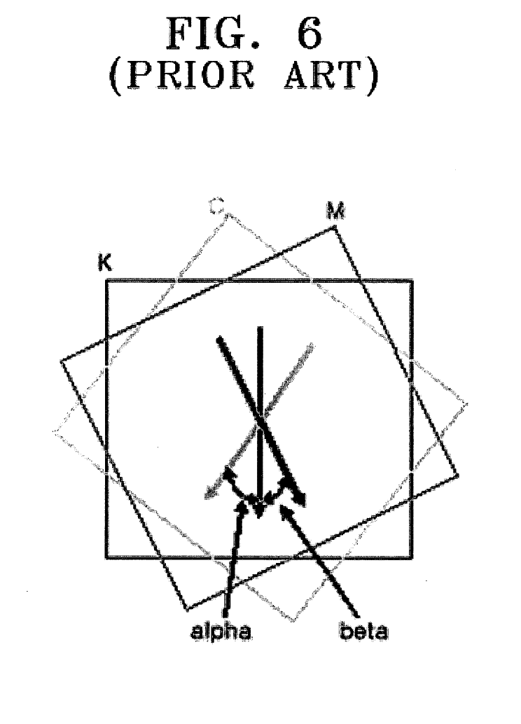

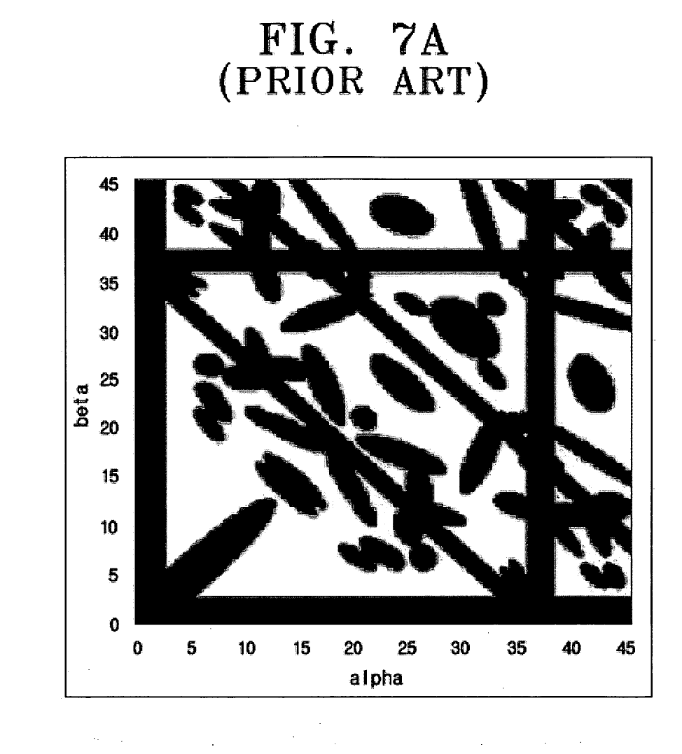

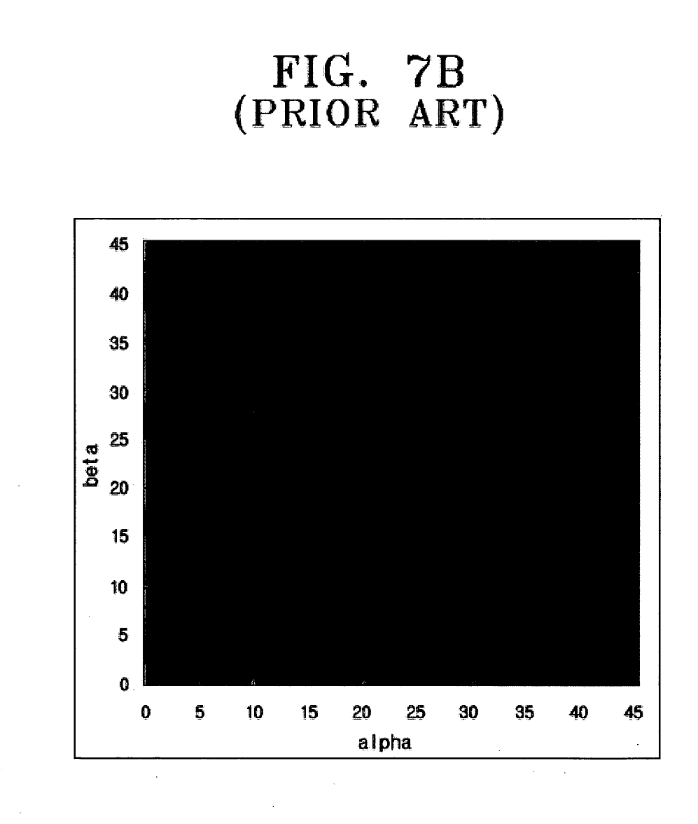

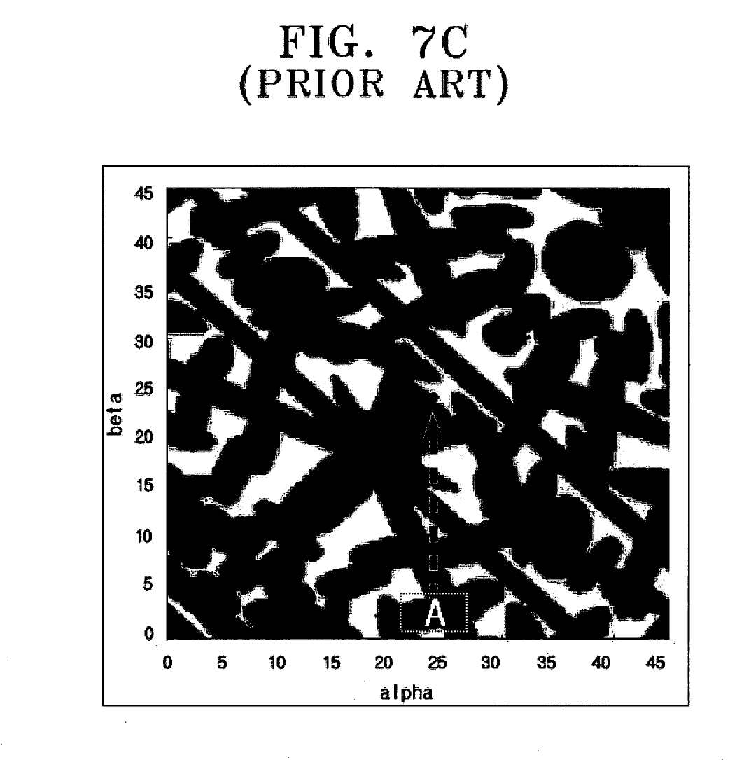

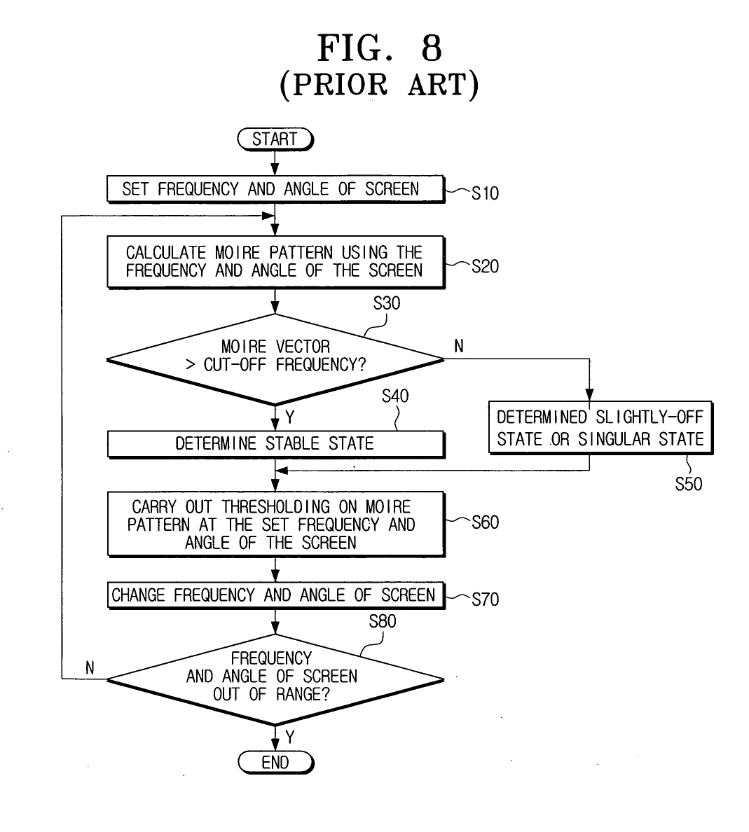

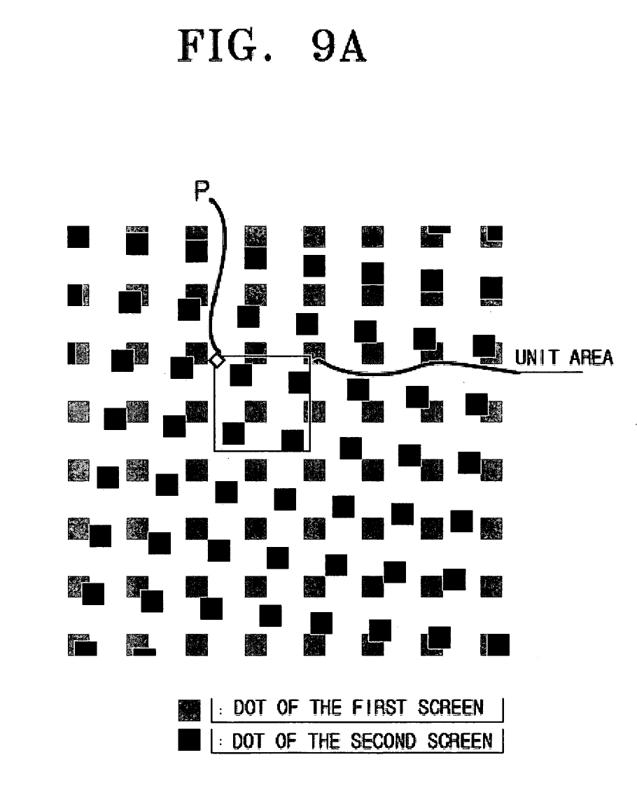

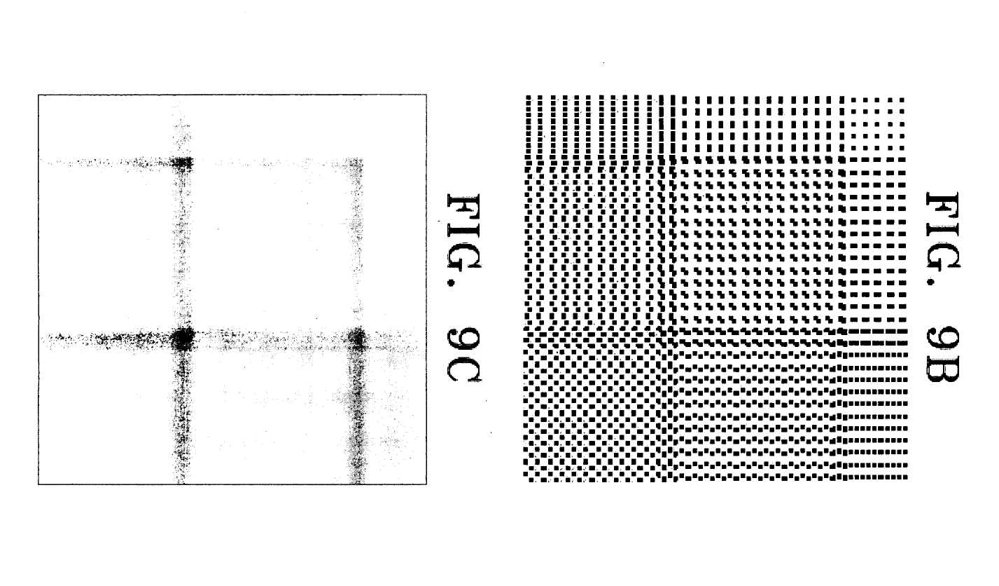

Throughout the drawings, like reference numerals will be understood to refer to like parts, components and structures.

### DETAILED DESCRIPTION OF EXEMPLARY EMBODIMENTS

Hereinafter, exemplary embodiments of the present invention are described in detail with reference to accompanying drawings.

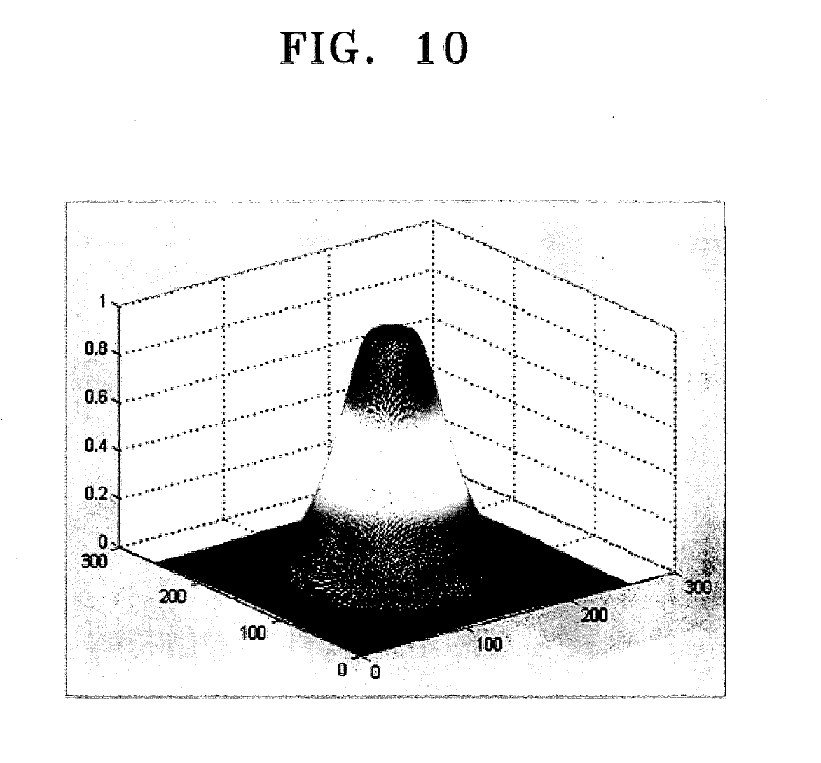

FIGS. 9A to 11B are views explaining a method of obtaining an average reflectivity of a binary image in accordance with an exemplary embodiment of the present invention.

Referring to FIG. 9A, dots of a first screen and dots of a second screen are arranged when the first and second screens overlap each other.

Referring to FIG. 9B, binary images are formed using the first and second overlapped screens shown in FIG. 9A. A distribution of frequency components (cost) with respect to such binary images is calculated using the following equation 4:

$$Cost = {\sum }_{α} {\sum }_{β} {MTF ( u , v )}^{2} ( X ( u , v ) \times X * ( u , v ) )$$

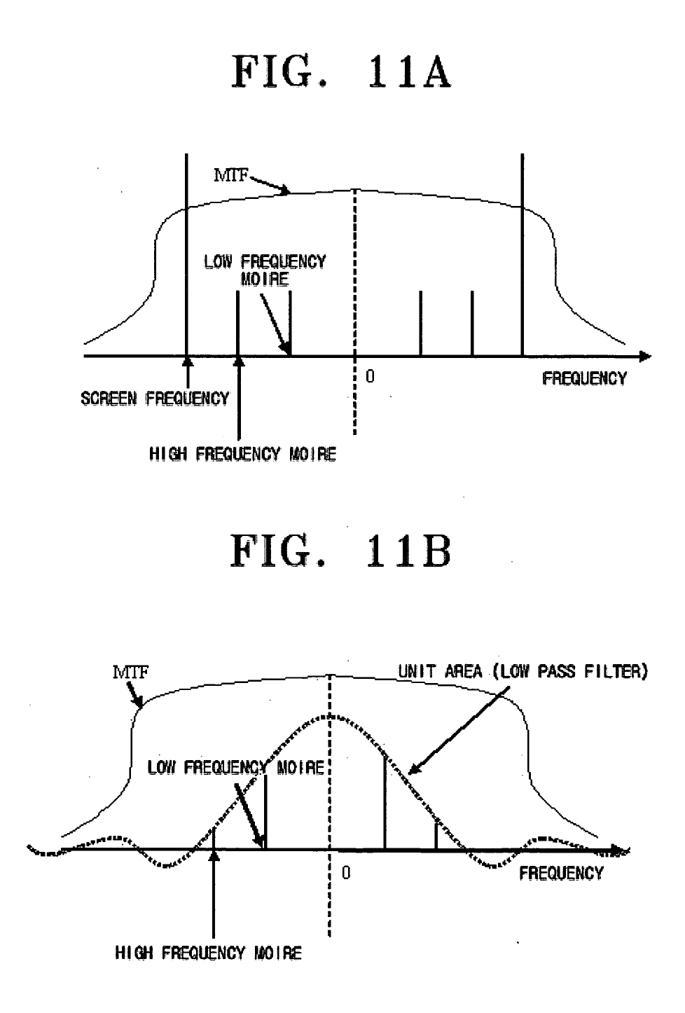

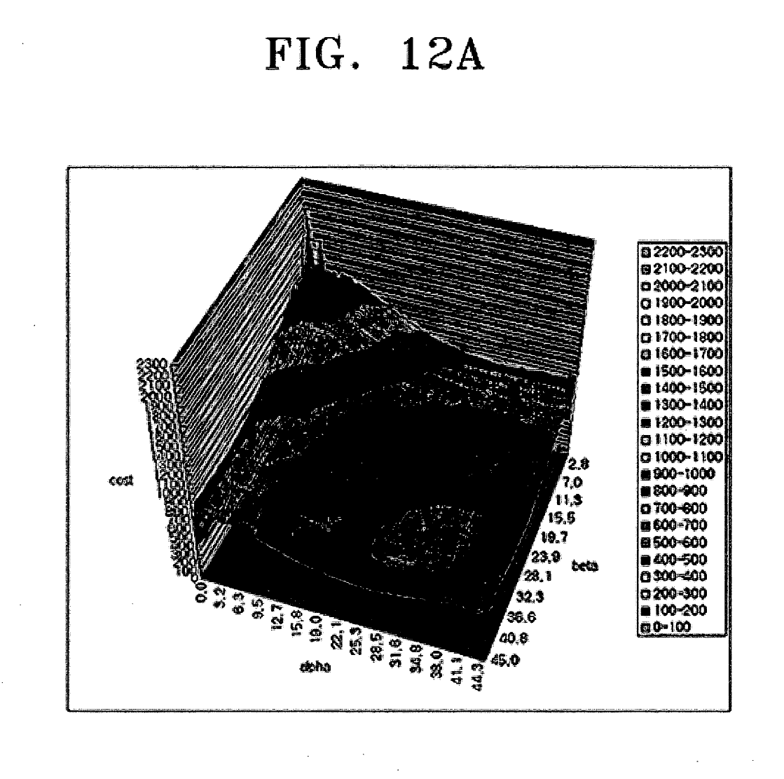

The MTF (modulation transfer function) is a visual property of a human being, which is shown in a frequency domain graph of FIG. 10. And X(u,v)×X*(u,v) is a power spectrum of the binary image, and FIG. 11A shows the power spectrum of the binary image shown in FIG. 9B.

Referring to FIG. 11A, because the screen frequency is higher than frequencies corresponding to a high frequency moire and a low frequency moire, a difference between the frequency components (cost) in response to frequency and angle of the screen are not able to be clearly identified. A visual property of a human being has a CSF (contrast sensitivity function) property of better recognizing a moire pattern when a predetermined frequency component is closer to a start point and has a bigger magnitude, so that the moire patterns are not clearly classified due to the screen frequency.

To cope with this problem, an average reflectivity of the binary image is taken into account, which is calculated in FIG. 9C so that a pure moire pattern without the screen frequency is shown in the same Figure. The binary image should be divided into predetermined unit areas to obtain the average reflectivity of the binary image, so that a size of the unit area should be set to be smaller than the screen frequency to remove the screen frequency, which will be described with reference to FIG. 9A.

Horizontal and vertical lengths of the unit area are set to be bigger than a distance between dot patterns of the screen as shown in FIG. 9A to remove the screen frequency. The unit area to be set may be circular, and a different weight value may be applied to the unit area in response to a pixel position. The equation 5 below is applied to the position ‘P’, represented as ⋄ in FIG. 9A, per unit area using the obtained unit area to calculate the average reflectivity of ‘P’, and the moire pattern of the binary image is detected using a collection of these values.
average reflectivity of ‘P’=number of white pixels within unit area/unit area Equation 5

The white pixel means a pixel where dots are not formed among pixels included in the unit area of the binary image printed onto the overlapped screen. The equation 5 takes a function of the low pass filter to the binary image to calculate the average reflectivity of the binary image.

According to the above-described method, the average reflectivity of the binary image shown in FIG. 9B may be calculated to show a pure moire pattern of the binary image where the screen frequency is removed as shown in FIG. 9C.

Equation 4 is applied to the moire pattern shown in FIG. 9C to calculate a distribution of the frequency components (cost) corresponding to the moire pattern. In this case, X(u,v)×X*(u,v) is a power spectrum of the moire pattern shown in FIG. 9C. FIG. 11B shows the power spectrum of the moire pattern shown in FIG. 9C.

Referring to FIG. 11B, the moire pattern of the binary image where the screen frequency is removed has a higher frequency in the low frequency moire than the high frequency moire. This is because a weight value is more applied to the low frequency moire to reflect the visual property of the human being while the average reflectivity of the binary image is calculated. That is, the low frequency moire is better recognized than the higher frequency moire by the human being.

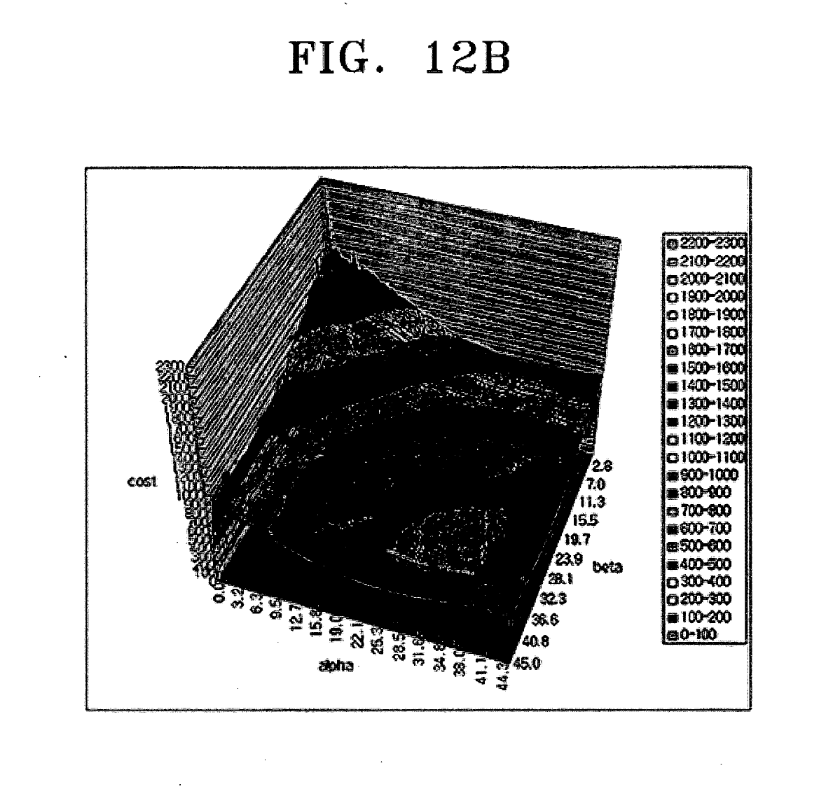

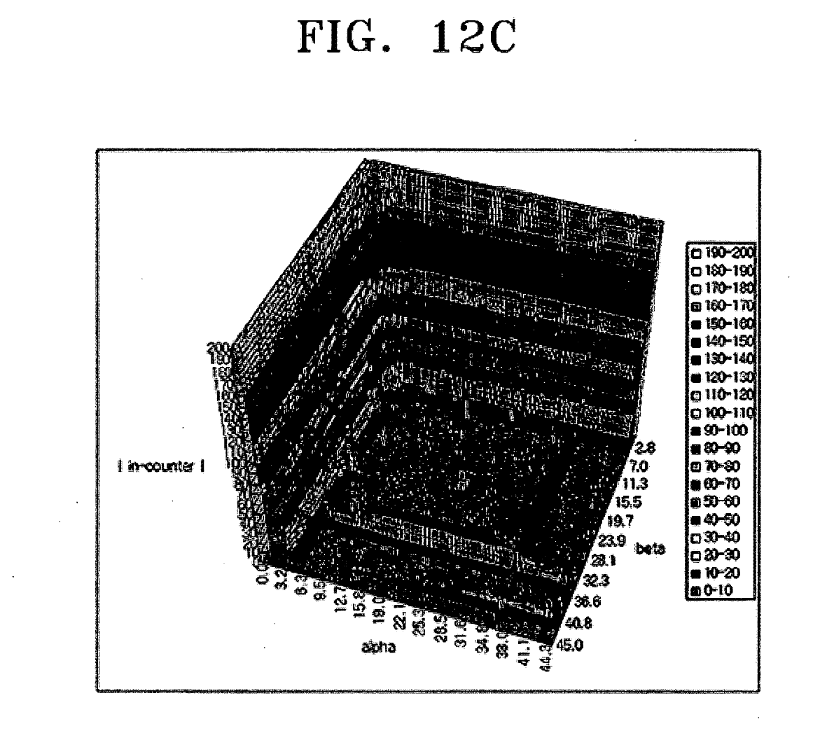

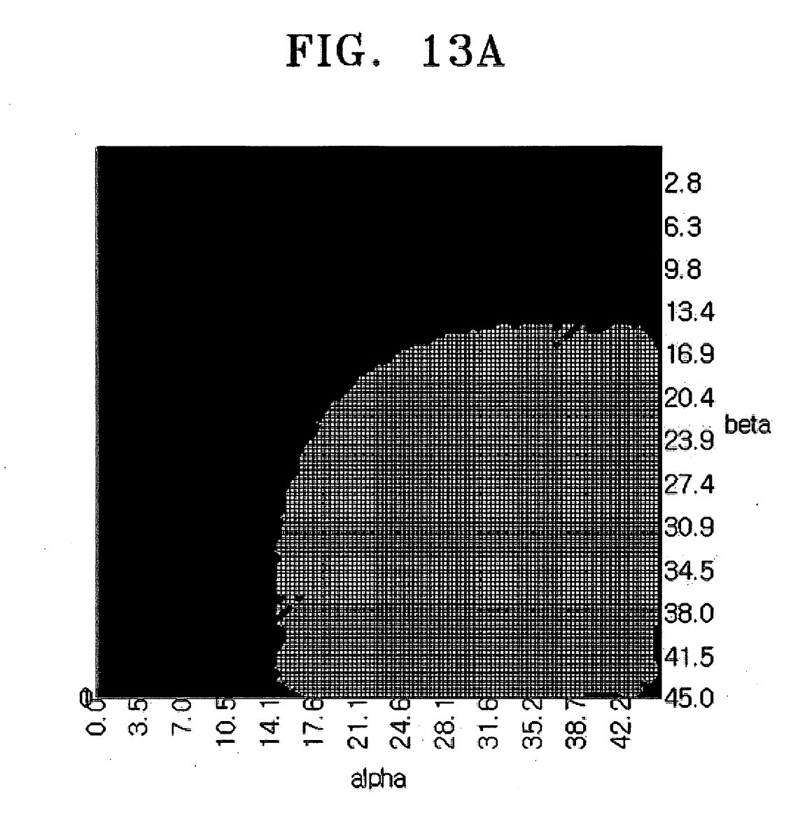

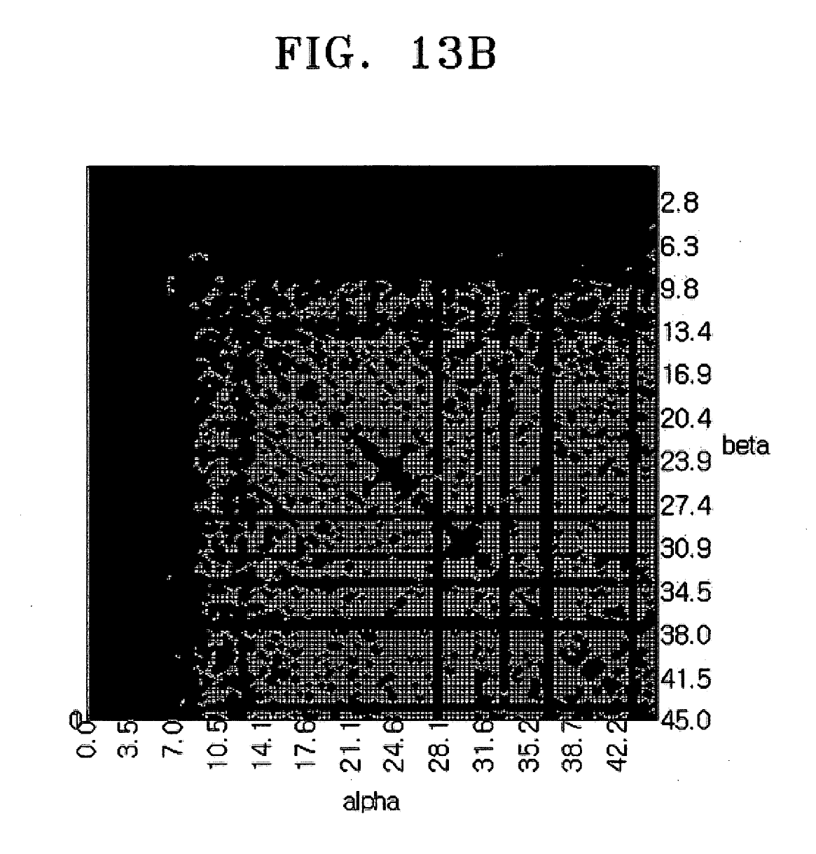

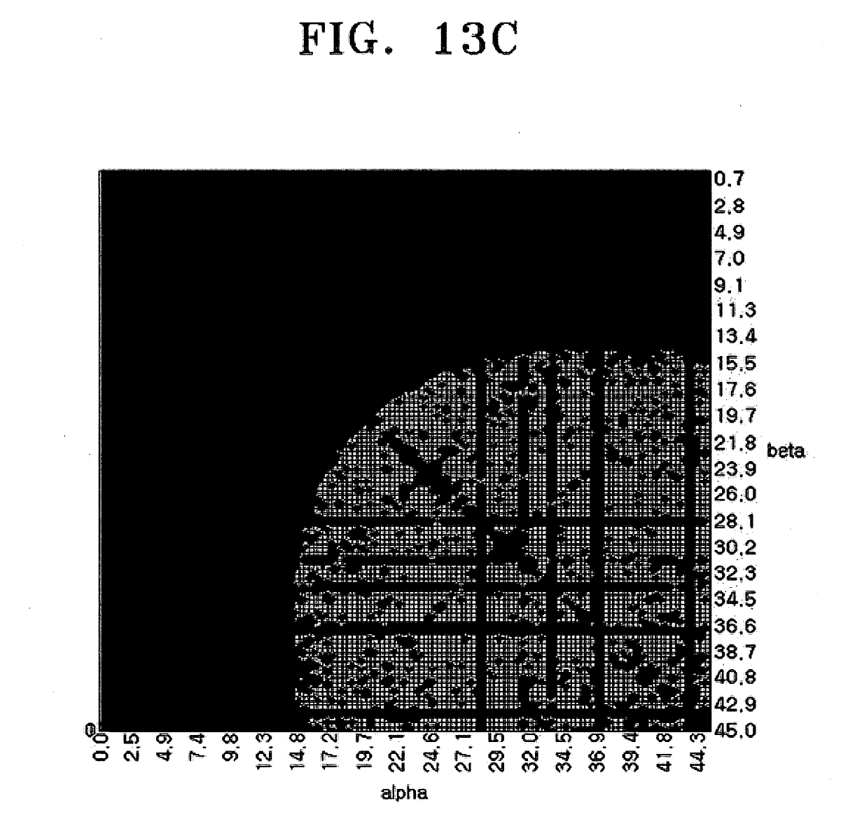

FIGS. 12A to 13D are views for explaining a method of carrying out thresholding on the moire pattern in accordance with an exemplary embodiment of the present invention.

Referring to FIGS. 12A and 12B, distributions of the frequency components (cost) are shown in accordance with an angle difference (α) between the black screen and the cyan screen and an angle difference (β) between the black screen and the magenta screen when frequencies of the cyan, magenta, and black screens are the same as one another (that is, q_{CK}=q_{MK}=1).

FIG. 12A shows a distribution of the frequency components in accordance with the angle differences α and β when screens overlap one another in an in-phase state in accordance with equation 4. In this case, an initial frequency (f_{K}) of the black screen is set to 751 lpi.

Poor patterns are not generated when the frequency component (cost) shown in FIG. 12A is smaller than a first threshold value, and poor patterns are generated in the remaining situations. In this case, the first threshold value is obtained as 575 by visual evaluation at a distance of 20 inches.

The poor patterns indicate low frequency patterns, such as high frequency pattern, and moire patterns, such as rosette. That is, when the poor patterns are not generated corresponds to a singular state or a stable state, and when the poor patterns are generated corresponds to a slightly-off state.

The singular state may be regarded as an unstable state, that is, the singular state indicates a state where the moire pattern may occur when fine changes in frequency and angle of the screen occur, so that a method of determining the singular and stable stages is required. Determination of the singular and stable states is made with reference to FIGS. 12B and 12C, which are described below.

FIG. 12B shows respective screens in the counter-phase overlapping state in response to equation 4, and shows a distribution of the frequency components (cost) in response to angle differences α and β when the initial frequency (f_{K}) of the black screen is 751 lpi. FIG. 12C shows a difference (|in-counter|) between the frequency components (cost) at the time of on-phase overlapping and the frequency components (cost) at the time of counter-phase overlapping.

The moire pattern is not generated when the difference (|in-counter|) between the two components (cost) shown in FIG. 12C is smaller than the second threshold value. The moire pattern is generated in the remaining situations. The second threshold value to be used is obtained as 3 by means of visual evaluation at a distance of 20 inches.

That is, in a case of the singular state, a significant difference between the frequency component (cost) at the time of in-phase overlapping and the frequency component at the time of counter-phase overlapping occurs, so that the difference (|in-counter|) between the two components (cost) exceeds the second threshold value. Contrastingly, when the stable state, an insignificant difference between the frequency component (cost) at the time of in-phase overlapping and the frequency component at the time of counter-phase overlapping occurs, so that the difference (|in-counter|) between the two components (cost) is smaller than the second threshold value. As such, by means of the difference (|in-counter|) between the two components (cost), determination is made on the singular state and the stable state.

FIG. 13A is a view illustrating, as a binary image, the presence and absence of the moire pattern at the time of in-phase overlapping of the respective screens. The white area indicates an area where the moire pattern is not generated, and the black area indicates an area where the moire pattern is generated. That is, the white area occurs when the frequency component (cost) is smaller than the first threshold value at the time of in-phase overlapping shown in FIG. 12A, and the black area occurs in the remaining situations.

FIG. 13B shows the white area when the difference (|in-counter|) between the two components (cost) shown in FIG. 12C is smaller than the second threshold value, and the black area occurs in the remaining situations.

FIG. 13C is a view illustrating a binary image that simultaneously satisfies the FIGS. 13A and 13B (that is, stable state). FIG. 13C shows the presence and absence of the moire in response to the angle difference α and β when frequencies of the C, M, and B screens are the same as one another.

FIG. 13D shows that the binary images shown in FIG. 13C are subject to thresholding in response to the frequency rate changes (q_{CK}=q_{MK}; which corresponds to 0.88 to 1.0) of the C, M, and B screens and are then accumulated. The point ‘A’ shown in FIG. 13D is a point corresponding to an optimal stable state where the moire pattern is not generated while the C, M, and B screens overlap one another, which is obtained from the angle difference (α=26.5°, β=23.0°) corresponding to the point ‘A’. In this case, the frequency rate interval to be used is 0.03.

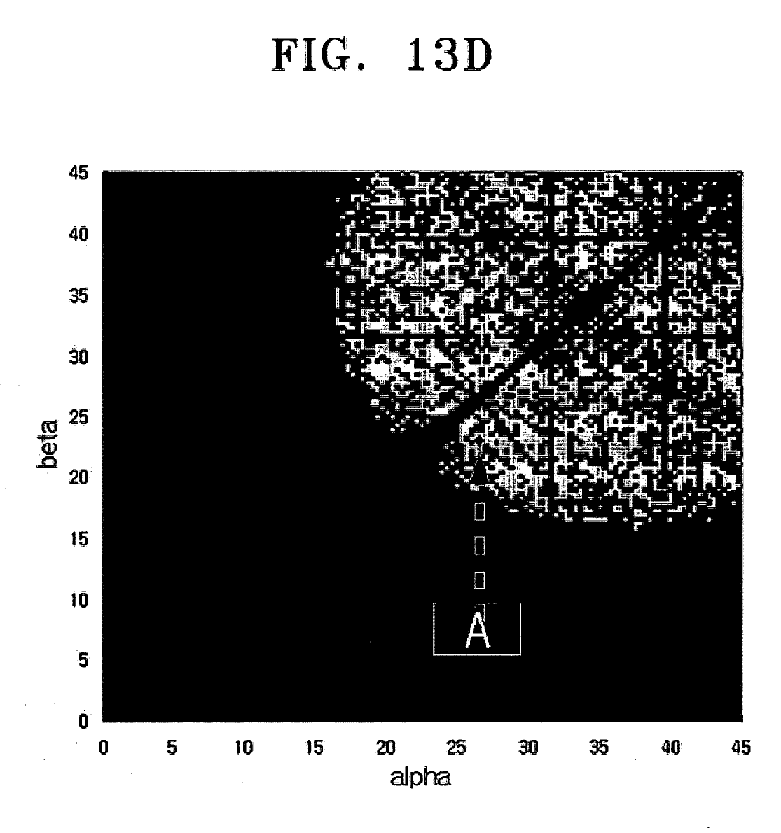

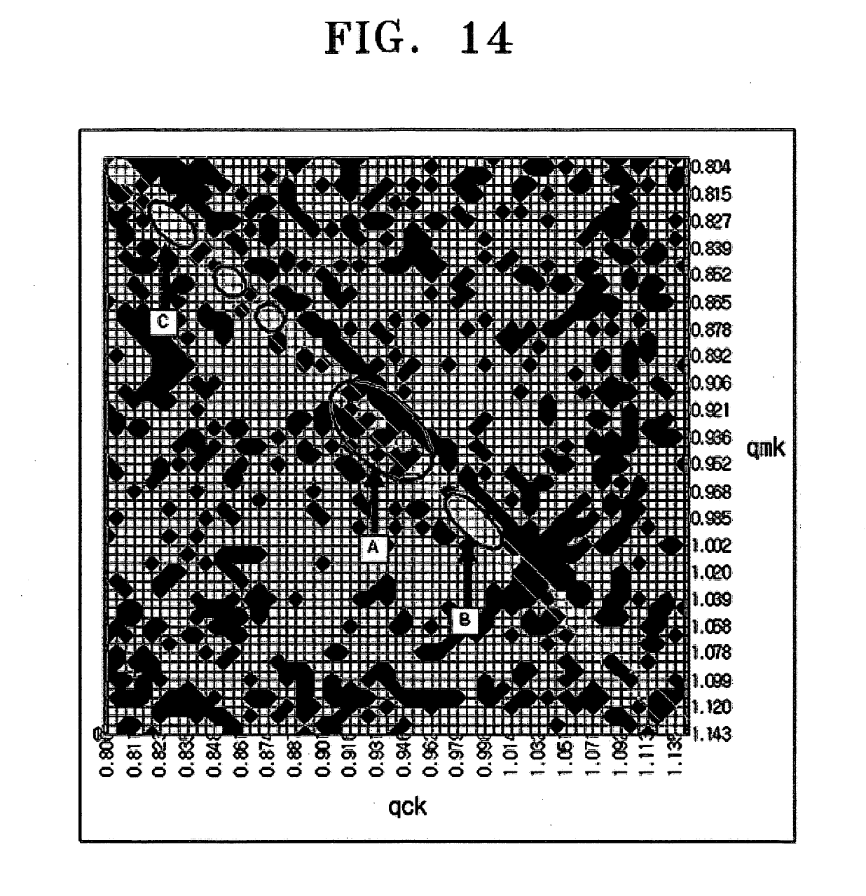

FIG. 14 is a view illustrating a pattern state in response to the frequency rate when the calculated angles α and β are fixed in accordance with an exemplary embodiment of the present invention.

FIG. 14 is an experimental result when the frequency rates (q_{CK} and q_{MK}) are changed per value of 0.005 when the angles (α=26.55°, β=23.0°) are fixed. As shown in FIG. 14, the moire pattern is present in the area ‘A’, and is not present in the areas ‘B’ and ‘C’. Such areas ‘B’ and ‘C’ correspond to the final stable state, and the following tables 1 and 2 show the angle difference and the frequency rate of the screen with respect to the areas ‘B’ and ‘C’.

TABLE 1

| | Angle difference between | Frequency rate between |
|---|---|---|
| Screen (area B) | screens | screens (q_{CK} = q_{MK}) |
| Black | 0 | 1 |
| Cyan | 26.5° (α) | 0.97˜0.99 (q_{CK}) |
| Magenta | 23.0° (β) | 0.97˜0.99 (q_{MK}) |

TABLE 2

| | Angle difference between | Frequency rate between |
|---|---|---|
| Screen (area C) | screens | screens (q_{CK} = q_{MK}) |
| Black | 0 | 1 |
| Cyan | 26.5° (α) | 0.82˜0.84 (q_{CK}) |
| Magenta | 23.0° (β) | 0.82˜0.84 (q_{MK}) |

The screen angles shown in Tables 1 and 2 indicate relative angles. For example, when the K screen has an angle of 10°, the C screen has an angle of 36.5° (=10°+26.5°) and the M screen has an angle of 77° (=10°-23.0°), and the B, M, and C screens may be replaced by one another. That is, when the C screen has an angle of 10°, the M screen may have an angle of 36.5° (=10°+26.5°) and the K screen may have an angle of 77° (=10°-23.0°).

As shown in FIG. 14, stable states in response to the frequency rates may be obtained in several areas, and the frequency rate and the angle differences with respect to the obtained areas may be applied to the laser printer, so that the moire pattern is not generated.

FIG. 15 is a flow chart explaining a method of carrying out thresholding on the moire pattern in accordance with an exemplary embodiment of the present invention.

Referring to FIG. 15, a user first sets frequency and angle of screens using a screen design device (not shown). That is, the frequency and the angle of the black screen are set to an initial frequency (f_{K}) and 0°, respectively, and the frequency and the angle of the cyan and magenta screens are set (S100).

After the overlapped screens are used to form an overlapped binary image, the equation 5 is used to calculate the average reflectivity with respect to the binary image where the screen frequency is removed (S110).

The calculated average reflectivity is used to calculate the frequency component (cost) when each screen is in the in-phase state (S115). The frequency component of the in-phase state is compared with the first threshold value (S120), and the slightly-off state is determined when the frequency component of the in-phase state is not less than the first threshold value. That is, it is determined that the moire pattern is generated (S125). In contrast, when the frequency component (cost) of the in-phase state is smaller than the first threshold value, it is determined that the moire pattern is not generated.

To determine the stable state and the singular state, the frequency component (cost) of the counter-phase state is calculated using the average reflectivity (S130). A difference (|in-counter|) between the frequency component of the counter-phase state and the frequency component of the in-phase state is calculated (S135).

The difference (|in-counter|) is compared with the second threshold value (S140), and the singular state is determined when the difference (|in-counter|) is not less than the second threshold value. That is, it is determined that the moire pattern may be possibly generated (S145). In contrast, when the difference (|in-counter|) is smaller than the second threshold value, the stable state is determined. That is, it is determined that the moire pattern is not generated (S150).

Thresholding is carried out on the moire pattern in response to the frequency and angle as set above (S160). Frequency and angle of the C and M screens are changed (S170). In this case, it is determined whether the change exceeds the frequency and the angle range of the screens, and the experiment is terminated when the change exceeds the frequency and the angle range. The steps S110 to S170 are repeatedly carried out when the change is within the range of the frequency and the angle of the screen (S180).

FIGS. 16A and 16b are views illustrating screening results in response to frequency rate and angle differences in accordance with an exemplary embodiment of the present invention. FIG. 16A corresponds to an in-phase overlapping case. FIG. 16B corresponds to a counter-phase overlapping case.

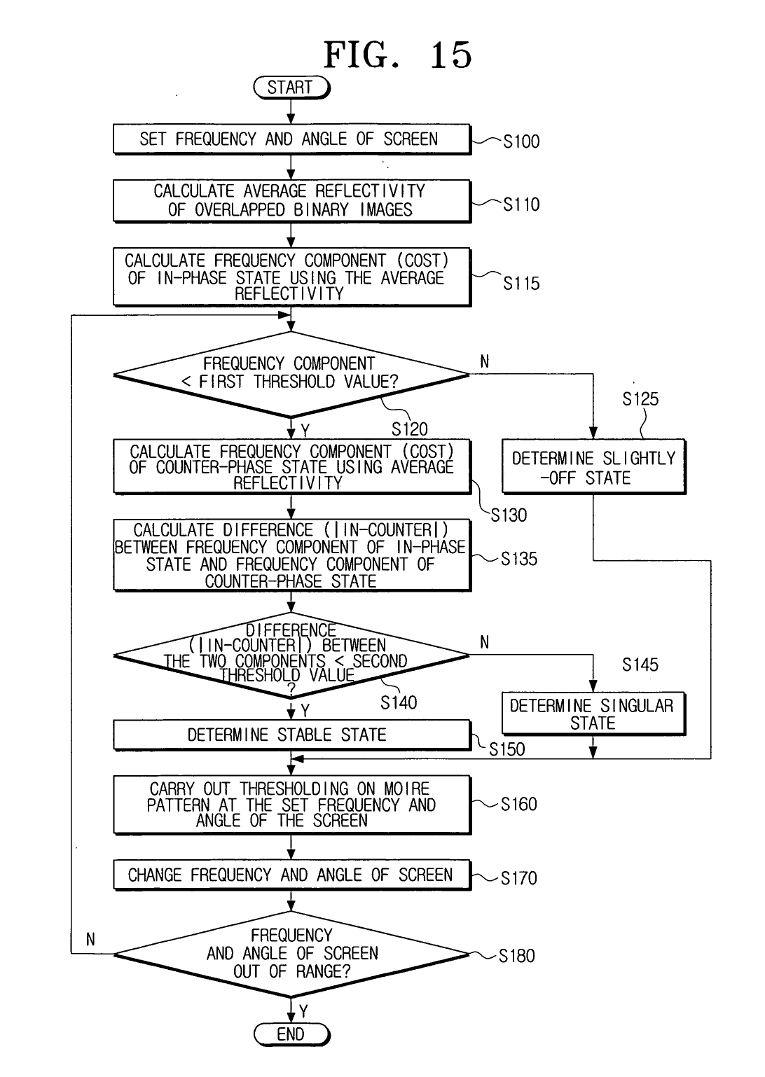

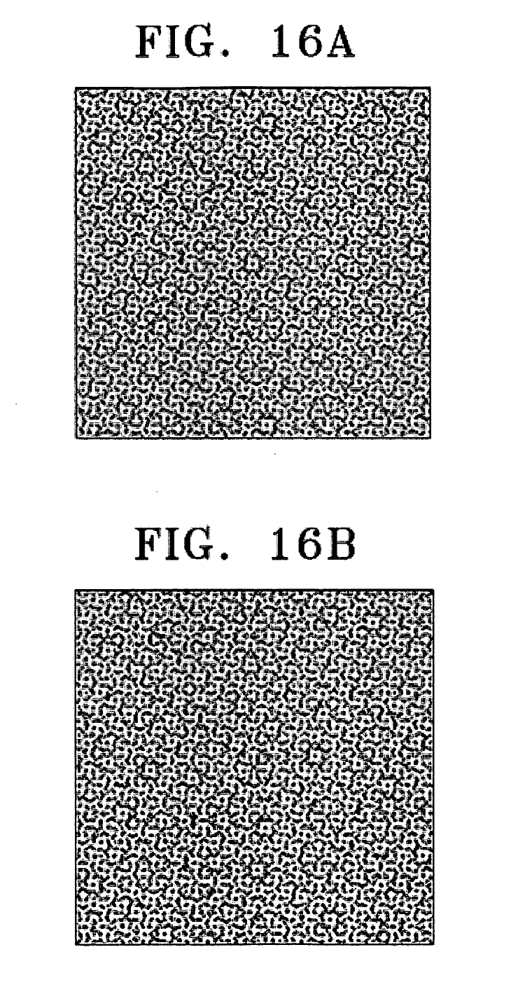

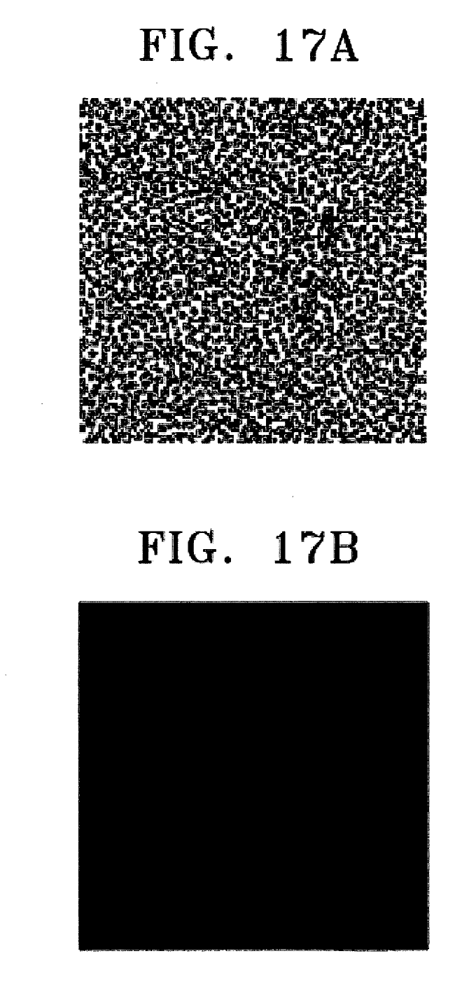

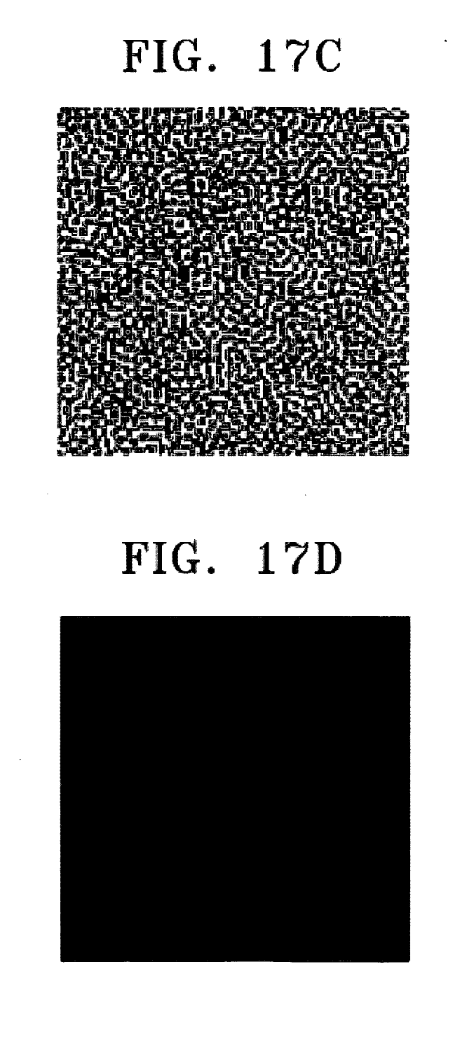

FIGS. 17A to 17D are views illustrating evaluation results of screens having AM stochastic property in accordance with an exemplary embodiment of the present invention.

FIG. 17A shows a binary image formed using the screen having an AM stochastic property. FIG. 17B is a view illustrating the average reflectivity of the binary image. FIG. 17C a binary image formed using the screen having an AM ordered property. FIG. 17D is a view illustrating the average reflectivity of the binary image.

Frequency components of FIGS. 17B and 17D have values of 0.600516 and 0.415865, respectively, and the unit area applied to FIG. 17 is not as shown but is substantially circular. The weight value is set for each pixel to have a Gaussian filter property.

According to exemplary embodiments of the present invention as described above, thresholding may be carried out on the moire pattern using the average reflectivity of the overlapped binary images, and the frequency and the angle of the screen where the moire pattern is not generated may be set by taking the difference between in-phase and counter-phase of the screen into account, which thus allows the user to cope with hardware changes and to obtain the property about the screen having the AM stochastic property and use it as an evaluation function at the time of design.

The foregoing embodiment and advantages are merely exemplary and are not to be construed as limiting the present invention. The present teaching may be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A method of setting frequency rate and angle differences between screens, comprising:
forming a binary image using at least two overlapped screens;
low-pass filtering the binary image to calculate an average reflectivity;
calculating a frequency component (cost) with respect to the binary image using the calculated average reflectivity; and
determining whether a moire pattern with respect to the binary image is generated based on the frequency component.

2. The method according to claim 1, wherein the calculating of the frequency component with respect to the binary image includes
calculating the frequency component when the at least two screens are in an in-phase state where start points of the screens are substantially the same.

3. The method according to claim 2, wherein
a slightly-off state in which the moire pattern is generated is determined using the calculated frequency component of the in-phase state.

4. The method according to claim 3, wherein
the binary image is determined to be in the slightly-off state when the calculated frequency component of the in-phase state exceeds a first threshold value.

5. The method according to claim 2, wherein the calculating of the frequency component with respect to the binary image further includes
calculating the frequency component when the at least two screens are in a counter-phase state where start points (0,0) of the screens are not the same.

6. The method according to claim 5, wherein the calculating of the frequency component with respect to the binary image further includes
calculating a difference between the frequency component of the in-phase state and the frequency component of the counter-phase state.

7. The method according to claim 6, wherein
the moire pattern is determined to be in a singular state using the calculated difference between the frequency component of the in-phase state and the frequency component of the counter-phase state.

8. The method according to claim 7, wherein
the binary image is determined to be in the singular state when the calculated difference between the frequency component of the in-phase state and the frequency component of the counter-phase state exceeds a second threshold value.

9. The method according to claim 7, wherein
the binary image is determined to be in a stable state when the calculated frequency component of the in-phase does not exceed the first threshold value and the calculated difference between the frequency component of the in-phase state and the frequency component of the counter-phase state does not exceed the second threshold value.

10. The method according to claim 1, wherein
an average reflectivity of a predetermined position P of the binary image is calculated using the following equation:
average reflectivity of P=a number of white pixels within unit area/unit area.

11. The method according to claim 10, wherein
horizontal and vertical lengths of the unit area are larger than a length of a dot pattern of the at least two screens.

12. The method according to claim 1, wherein
the calculating of the frequency component (Cost) with respect to the binary image includes using equation:
$$Cost = {\sum }_{α} {\sum }_{β} {MTF ( u , v )}^{2} ( X ( u , v ) \times X * ( u , v ) )$$
where the MTF (modulation transfer function) denotes a visual property of a human being, X(u,v)×X*(u,v) denotes a power spectrum of the binary image, and α and β denote angle differences between the at least two screens.

13. The method according to claim 1, wherein
carrying out thresholding when the moire pattern is generated.

14. The method according to claim 13, wherein setting frequency rate and angle differences between the at least two screens based on the thresholding value.
